(19) United States
(12) Patent Application Publication
(10) Pub. No.: US 2026/0315326 A1
(43) Pub. Date: Oct. 15, 2026

(54) Universal Adapter for Closed-System Drug Transfer Device

(71) Applicant: Becton, Dickinson and Company, Franklin Lakes, NJ (US)

(72) Inventors: Niranjan Lekkala, Bangalore (IN); Leah Paige Gaffney, Cambridge, MA (US); Narsi Reddy Sanikommu, Kanigiri (IN); Abin Austin, Thrissur (IN); Ryan Callahan, Long Beach, CA (US); Amarsinh Deeliprao Jadhav, Hyderabad (IN); Nicole Jean DiStefano, Dumont, NJ (US)

(21) Appl. No.: 19/485,352

(22) PCT Filed: May 14, 2024
(86) PCT No.: PCT/US2024/029182

§ 371 Date: Nov. 18, 2025

(30) Foreign Application Priority Data
May 27, 2023 (IN) 202311036757

(51) Int. Cl. A61J 1/20

(52) U.S. Cl. CPC A61J 1/2055; A61J 1/201; A61J 1/2075

(57) ABSTRACT

Provided herein is a vial adapter for accessing a vial. The vial adapter includes a base having a distal side and a proximal side, with a base lumen extending between the distal side and the proximal side. The vial adapter also includes a first connector positioned at the distal side of the base and configured to couple with the vial, a second connector positioned at the proximal side of the base and configured to couple with a fluid container, and a spike member extending distally from the base and configured to pierce through a stopper of the vial, the spike member defining a spike lumen in fluid communication with the base lumen. The first connector is positioned on the spike member and includes an arm structure configured to engage the stopper, to secure the vial adapter to the vial.

### CROSS-REFERENCE TO RELATED APPLICATION

The present application claims priority to Indian Provisional Application No. 202311036757 entitled “Universal Adapter for Closed-System Drug Transfer Device” filed May 27, 2023, the disclosure of which is hereby incorporated by reference in its entirety.

### BACKGROUND OF THE INVENTION

### Field of the Invention

The present disclosure relates generally to closed-system drug transfer devices and, more specifically, to a universal adapter for closed-system drug transfer devices that may be coupled to vials of various sizes.

### Description of Related Art

Healthcare providers and medical device and pharmaceutical manufacturers, as well as, leading governmental and regulatory agencies, have long recognized the issues healthcare workers face with compounding and administering hazardous drugs. For example, nurses treating cancer patients risk being exposed to chemotherapy drugs when compounding and administering these drugs, and this unintentional chemotherapy exposure can affect the nervous system, impair the reproductive system, and/or bring an increased risk of developing blood cancers in the future.

In order to reduce the risk of healthcare workers being exposed to hazardous drugs, the closed transfer of these drugs becomes important, with various policies and regulations having been implemented that require the use of closed-system drug transfer devices (CSTDs) when compounding and administering hazardous drugs. A CSTD is connected to a vial containing the hazardous drug-via an adapter or vial access device-with the CSTD providing for a safe removal of the hazardous drug from the vial and a subsequent compounding or administering of the drug. The CSTD may utilize a physical barrier that inhibits the escape of the hazardous drug substance to thereby mitigate the exposure risk to the healthcare worker who may compound or administer hazardous drugs to patients.

As indicated above, an adapter or access device is typically used for coupling a CSTD to a vial. One shortcoming of existing adapters is their lack of suitability to be used with drug vials of differing types and/or sizes. That is, the size of drug vials within which the hazardous drug (e.g., chemotherapy drug) is provided can vary depending on the type and recommended dosage of the drug being administered, and the size of the vial head (with opening therein) will thus also vary. Existing CSTD adapters are typically designed so as to only mate with a vial head of a specified size, meaning that CSTD adapters of various configurations must be kept on-hand at a healthcare facility in order to accommodate vials of different sizes. The need for multiple adapter configurations may unnecessarily complicate the workflow at the healthcare facility and increase costs.

Accordingly, a need exists in the art for a universal CSTD adapter that is able to connect to hazardous drug vials of various sizes and constructions.

### SUMMARY OF THE INVENTION

Provided herein is a vial adapter for accessing a vial. The vial adapter includes a base having a distal side and a proximal side, with a base lumen extending between the distal side and the proximal side. The vial adapter also includes a first connector positioned at the distal side of the base and configured to couple with the vial, a second connector positioned at the proximal side of the base and configured to couple with a fluid container, and a spike member extending distally from the base and configured to pierce through a stopper of the vial, the spike member defining a spike lumen in fluid communication with the base lumen. The first connector is positioned on the spike member and includes an arm structure configured to engage the stopper, to secure the vial adapter to the vial.

In some embodiments, the first connector includes a sleeve member positioned about the spike member, adjacent a proximal end of the spike member so as to abut the base, with the sleeve member including a plurality of slots formed therein. The first connector also includes a plurality of pre-loaded arms forming the arm structure, the plurality of pre-loaded arms positioned within the sleeve member and biased radially outward away from the spike member and towards the sleeve member. The plurality of pre-loaded arms is rotatable relative to the sleeve, such that an end of each of the plurality of pre-loaded arms may be brought into alignment with a respective slot of the plurality of slots and be actuated out through the slot, such that a portion of each of the plurality of pre-loaded arms is positioned outside of the sleeve member.

In some embodiments, upon insertion of the spike member into the stopper, the sleeve member is retained by the stopper to prevent rotation of the sleeve member relative to the stopper, and wherein a subsequent rotation of the vial adapter causes the plurality of pre-loaded arms to be actuated out through the plurality of slots.

In some embodiments, an adhesive applied onto an outer surface of the sleeve member, the adhesive configured to adhere the sleeve member to the stopper.

In some embodiments, the first connector includes an arm guide positioned about the spike member and translatable axially along the spike member and a plurality of expandable arms forming the arm structure, the plurality of expandable arms configured to deflect radially inward and outward relative to the spike member. Each of the plurality of expandable arms further includes a distal end joined to the spike member and a proximal end movable within the arm guide.

In some embodiments, upon insertion of the spike member into the stopper, the arm guide is caused to translate proximally along the spike member, such that the proximal end of the each of the plurality of expandable arms is removed from the arm guide, with the plurality of expandable arms engaging with the stopper and applying a radially outward directed pressure against the stopper.

In some embodiments, the arm structure of the first connector includes one or more cantilevered retaining arms, with each of the one or more cantilevered retaining arms joined to the spike member adjacent a distal end of the spike member and angled radially outward away from the spike member. Each of the one or more cantilevered retaining arms is configured to deflect radially inward toward the spike member.

In some embodiments, insertion of the spike member into the stopper causes the one or more cantilevered retaining arms to contact the stopper and deflect radially inward. Upon the spike member being fully forced through the stopper, the one or more cantilevered retaining arms are positioned distally from the stopper and move radially outward back to a default position, with the one or more cantilevered retaining arms engaging a back surface of the stopper.

In some embodiments, the second connector includes a connector lumen extending through the second connector and in fluid communication with the base lumen and the spike lumen.

In some embodiments, the spike member includes a vent lumen formed therein and wherein the vial adapter further includes a pressure equalization member coupled to the base and in fluid communication with the vent lumen.

Another vial adapter for accessing a vial is provided herein. The vial adapter includes a base having a distal side and a proximal side, with a base lumen extending between the distal side and the proximal side. The vial adapter also includes a first connector positioned at the distal side of the base and configured to couple with the stopper, a second connector positioned at the proximal side of the base and configured to couple with a fluid container, and a spike member extending distally from the base and configured to pierce through a stopper of the vial, the spike member defining a spike lumen in fluid communication with the base lumen. The first connector includes a plurality of grasping arms extending distally and radially outward from the distal side of the base, each of the plurality of grasping arms having a first end joined to or engaged with the base and a second end opposite the first end, and an actuating member engageable by a user to cause the second end of each of the plurality of grasping arms to move radially inward, thereby bringing the plurality of grasping arms into contact with the vial, to secure the vial adapter to the vial.

In some embodiments, each of the plurality of grasping arms is a flexible side arm configured to deflect radially inward.

In some embodiments, the actuating member is a zip tie looped through an engagement feature formed on each of the plurality of side arms, wherein a tightening of the zip tie causes the second end of each of the plurality of side arms to deflect radially inward and into contact with the vial.

In some embodiments, the engagement feature includes one of a hook or channel formed adjacent the second end of the side arm and that secures the zip tie to the side arm or one or more holes formed in the side arm, with the zip tie routed through a respective hole of the one or more holes to secure the zip tie to the side arm.

In some embodiments, the actuating member is an elastomeric ring engaged with each of the plurality of side arms at the second end thereof, and wherein the elastomeric ring applies a constricting force that causes the second end of each of the plurality of side arms to deflect radially inward and into contact with the vial.

In some embodiments, the first connector is a track system, with the plurality of grasping arms comprising a plurality of snap arms each including a pair of grooved tracks formed at the first end thereof, and with the actuating member comprising tooth members provided on a track housing positioned on the proximal side of the base, with the tooth members and the grooved tracks interacting to enable movement of the plurality of snap arms radially inward.

In some embodiments, each of the plurality of snap arms is a generally C-shaped member, with the first end oriented parallel to an upper surface of the vial and having the grooved track formed thereon, and with the second end oriented parallel to the first end.

In some embodiments, the first end is spaced apart from the second end by a distance that accommodates positioning of a head portion of the vial within a channel defined by the C-shaped grasping arms.

In some embodiments, the plurality of snap arms are movable radially inward relative to the base, and wherein upon the plurality of snap arms being movable radially inward and into contact with the vial, engagement of the tooth members with the grooved tracks locks the plurality of snap arms in place.

In some embodiments, the spike member includes a vent lumen formed therein and wherein the vial adapter further includes a pressure equalization member coupled to the base and in fluid communication with the vent lumen.

### BRIEF DESCRIPTION OF THE DRAWINGS

FIG. 1 is a perspective view of a closed-system drug transfer device (CSTD) with which embodiments of the disclosure may be implemented;

FIG. 2 is a perspective view of a vial adapter, according to an embodiment of the disclosure;

FIG. 3 is a perspective view of the vial adapter of FIG. 2, shown coupled to a vial;

FIG. 4 is a cross-sectional view of the vial adapter and vial of FIG. 3;

FIG. 5A is a detailed perspective view of a first connector included in the vial adapter of FIG. 2, in a non-actuated state;

FIG. 5B is a bottom view of the first connector of FIG. 5A;

FIG. 6A is a detailed perspective view of a first connector included in the vial adapter of FIG. 2, in an actuated state;

FIG. 6B is a bottom view of the first connector of FIG. 6A;

FIG. 7 is a perspective view of a vial adapter, according to another embodiment of the disclosure;

FIG. 8 is cross-sectional view of the vial adapter of FIG. 7, shown coupled to a vial;

FIG. 9 is a perspective view of a vial adapter, according to another embodiment of the disclosure;

FIG. 10 is a cross-sectional view of the vial adapter of FIG. 9, shown coupled to a vial;

FIG. 11 is a front perspective view of a vial adapter, according to another embodiment of the disclosure;

FIG. 12 is a bottom perspective view of the vial adapter of FIG. 11;

FIG. 13 is a perspective view of the vial adapter of FIG. 11, shown coupled to a vial;

FIG. 14 is a cross-sectional view of the vial adapter and vial of FIG. 13;

FIG. 15 is a perspective view of a vial adapter, according to another embodiment of the disclosure;

FIG. 16 is a perspective view of a vial adapter, according to another embodiment of the disclosure;

FIG. 17 is a perspective view of a vial adapter, shown coupled to a vial, according to another embodiment of the disclosure;

FIG. 17A is a detailed perspective view of a portion of the vial adapter of FIG. 17;

FIG. 18 is a cross-sectional view of the vial adapter and vial of FIG. 17, with a first connector of the vial adapter in an initial position; and

FIG. 19 is a cross-sectional view of the vial adapter of FIG. 17, with a first connector of the vial adapter in an engaged position.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, equivalents, variations, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used in this specification, the words “proximal” and “distal” refer to the direction closer to and away from, respectively, a user who would place the device into contact with another component or with a patient. Thus, for example, the end of a device first contacting another component or the body of the patient would be the distal end, while the opposite end of the device being manipulated by the user would be the proximal end of the device.

The terms “first”, “second”, and the like are not intended to refer to any particular order or chronology, but refer to different conditions, properties, or elements.

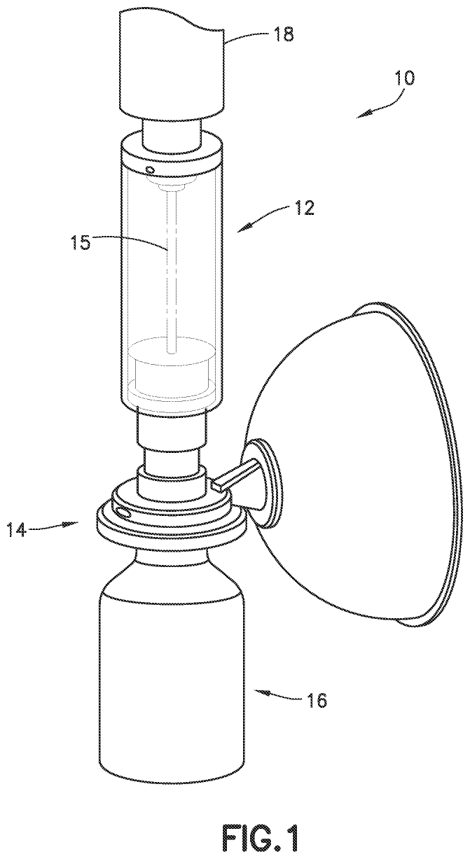

Referring to FIG. 1, shown is a non-limiting embodiment of a system 10 for the closed transfer of fluids (i.e., a closed-system drug transfer device (CSTD) 10) with which aspects of the disclosure may implemented. The CSTD 10 includes a syringe adapter 12 and a vial access device or vial adapter 14. The CSTD 10 provides substantially leak-proof sealing during engagement of a cannula (shown in phantom at 15) of the syringe adapter 12 with a vial 16, during transfer of a substance from the vial 16 to the syringe adapter 12 (and to a syringe 18 connected thereto) via the cannula 15, and during disengagement of the cannula 15 from the vial 16. The leak-proof sealing of the CSTD 10 substantially prevents leakage of both air and liquid during use of the CSTD 10. The CSTD 10 is compatible with a syringe 18 for accessing a medication contained within the vial 16 for administering the medication to a patient. The CSTD 10 is also compatible to be used with IV bags, IV lines, patient connectors, or other aspects to move fluids from the vial to another device or component.

According to aspects of the disclosure, vial adapters 14 are described herein that may be included in a CSTD 10, with the vial adapters 14 configured as universal adapters that accommodate vials 16 of differing types and/or sizes. The vial adapters 14 are suitable for use with the syringe adapter 12 included in existing CSTDs 10 that are commercially available, such as the syringe adapter included in the PhaSeal™ system from Becton, Dickinson and Company, for example. As will be described in detail below, the vial adapters 14 may include either an internal or external locking or coupling mechanism that allows the vial adapter 14 to be secured to a range of vial sizes.

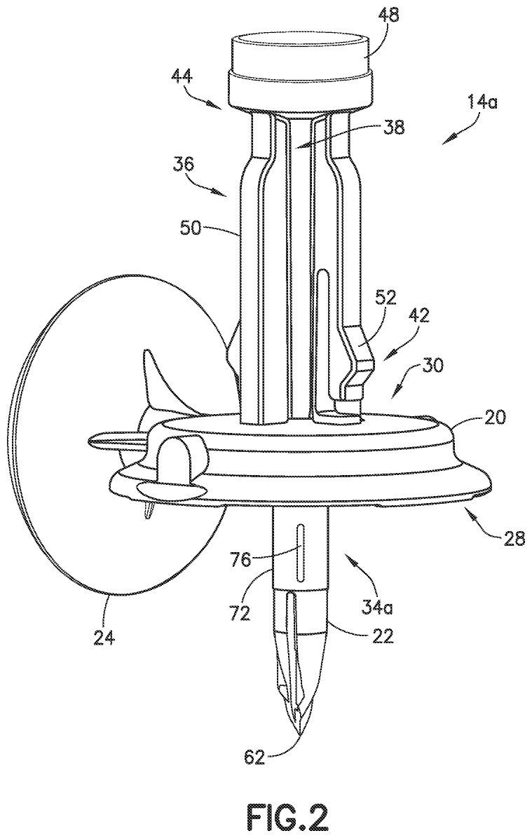

Referring now to FIGS. 2-6, a vial adapter 14a is shown in accordance with an embodiment of the disclosure. The vial adapter 14a includes a base 20, a spike member 22, and a pressure equalization chamber 24. In some embodiments, the base 20, spike member 22, and pressure equalization chamber 24 are formed as a single, integral component, and may be formed from a polymeric material, such as injection-molded polypropylene, although other suitable materials may be utilized. In other embodiments, the spike member 22 and the pressure equalization member 24 may be connected to the base 20 via a suitable connection.

The base 20 may be configured as a generally circular or cylindrical component having a circumference that is slightly larger than that of a head portion 26 of the vial 16. The base 20 includes a distal side 28 that faces a vial 16 to which the vial adapter 14a is to be connected, and a proximal side 30 that faces the syringe adapter 12 that is to be connected to the vial adapter 14a. In some embodiments, each of the distal side 28 and the proximal side 30 of base 20 is configured to have a generally planar structure, with the planar structure of the distal side 28 enabling flush contact to be made when the vial adapter 14a is secured to the vial 16. Within the base 20, a fluid lumen 32 is defined that allows for a transfer of fluid out from the vial 16, as will be explained in further detail below.

Provided on the base 20 are a first connector 34a and a second connector 36 that, according to embodiments, may either be integrally formed with the base 20 or connected thereto. The first connector 34a is provided on the distal side 28 of base 20 and the second connector 36 is provided on the proximal side 30 of base 20. The first connector 34a is configured to be secured to a vial 16, as previously shown and described in FIG. 1. The second connector 36 is configured to be secured to a syringe adapter 12 (and in further fluid communication with a syringe 18, or other fluid container), as shown and described in FIG. 1.

The second connector 36 includes a central shaft 38 that is formed integrally with the base 20 and that extends out proximally from the base 20. A lumen 40 is formed within the central shaft 38 that extends between a distal end 42 and a proximal end 44 of the second connector 36, with the lumen 40 fluidly connected to the lumen 32 in base 20. The lumen 40 ends at a proximal opening 46 provided at the proximal end 44 of the central shaft 38, and a seal (not shown) may be provided over the proximal opening 42 that may be pierced by a cannula 15 of the syringe adapter 12 (FIG. 1). A port 48 is provided at the proximal end 44 of the central shaft 38 that provides access to the lumen 40 when the syringe adapter 12 is connected thereto. The central shaft 38 may include an arrangement of flanges 50 and snap-fit fingers 52 that protrude radially outward therefrom and that mate with the syringe adapter 12 when the syringe adapter 12 is slid linearly downward onto the second connector 36. That is, while not shown in FIGS. 2-4, it is recognized that the flanges 50 and snap-fit fingers 52 would engage with guiding grooves formed on an interior surface of the syringe adapter 12, with the snap fit fingers 52 flexing and forming a snap-fit engagement with the grooves to secure the syringe adapter 12 to the vial adapter 14a.

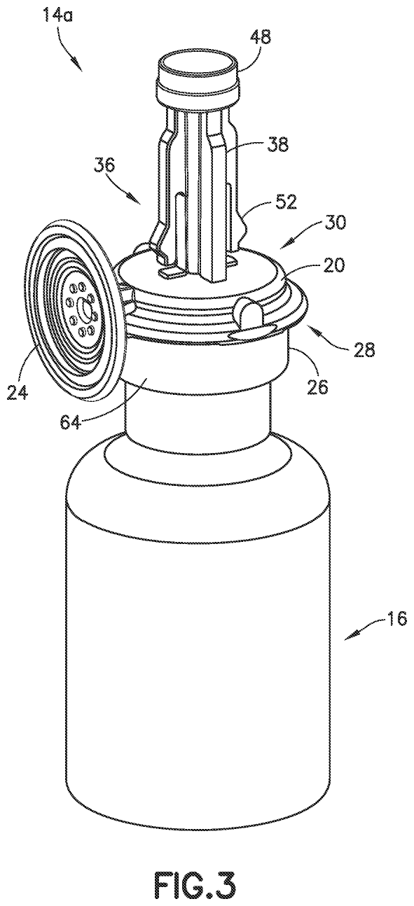

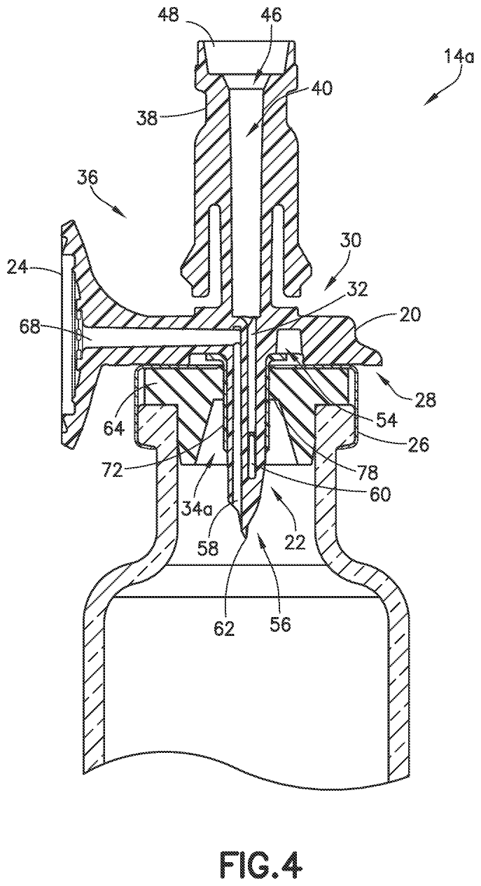

The spike member 22 extends distally away from the distal side 28 of base 20 and includes a proximal end 54 and a distal end 56. The spike member 12 defines a vent lumen 58 and a fluid lumen 60 that extend a length of the spike member 22, with the fluid lumen 60 in fluid communication with the lumen 32 in base 20 and the lumen 40 in second connector 36. The spike member 22 includes a pointed tip 62 at the distal end 56 thereof that is configured to pierce a stopper 64 (or other sealing member) on the vial 16 during connecting of the vial adapter 14 and vial 16, as shown in FIGS. 3 and 4. The vent lumen 58 and the fluid lumen 60 each include proximal and distal openings, respectively. While not shown, it is recognized that the fluid lumen 60 is configured to receive a cannula from the syringe adapter 12, which extends through the base 20 (i.e., through the lumen 32 of base 20) of the vial adapter 14a to permit fluid to be transferred through the cannula between the vial 16 and a fluid container (e.g., syringe 18) coupled to the syringe adapter 12. The fluid lumen 60 extends in a longitudinal (axial) direction of the spike member 22 between the proximal and distal ends 54, 56 thereof.

The pressure equalization chamber 24 is provided on the base 20 and extends radially outward therefrom. The pressure equalization chamber 24 has a generally parabolic shape and is in fluid communication with the vent lumen 58 of the spike member 22 via a pressure chamber channel 66 (FIG. 4), which extends partially into the base 20 and about perpendicular to the vent lumen 58. The pressure chamber channel 66 has an opening 68 that is positioned substantially at the center of the chamber 24. While not shown in FIGS. 2-4, it is recognized that the pressure equalization chamber 24 would have an expandable bladder provided thereon that encloses a volume within the chamber, with the bladder being moveable between an unexpanded state and an expanded state to maintain a predetermined pressure within the vial 16 during fluid transfer out therefrom.

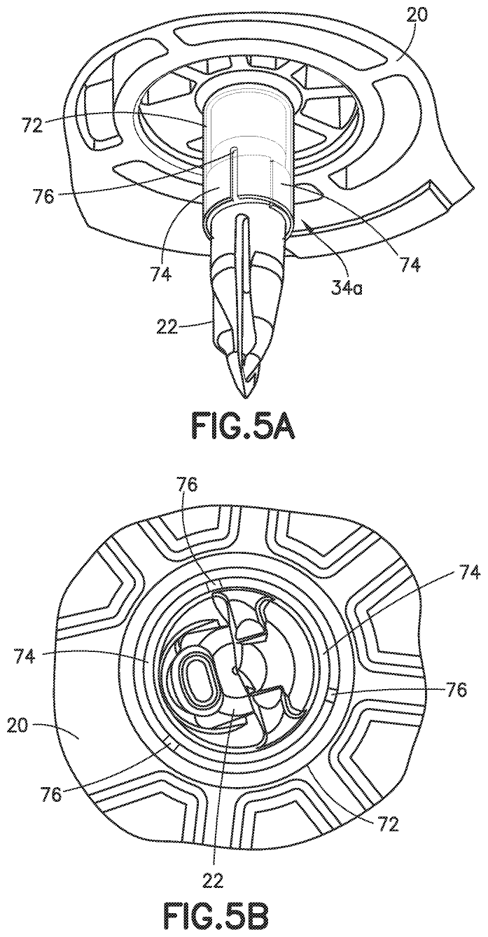

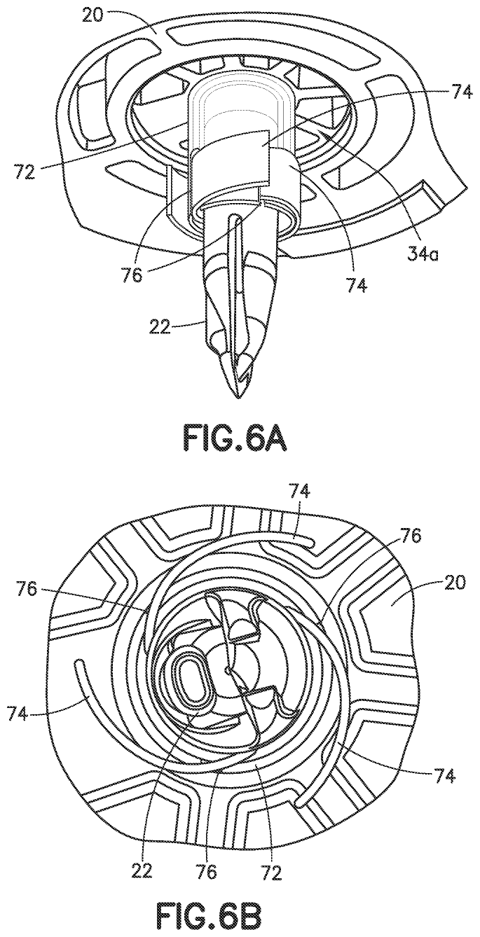

As indicated above, the first connector 34a is provided on the distal side 28 of base 20 and is configured to connect the vial adapter 14a to the vial 16. In the embodiment illustrated in FIGS. 2-6, first connector 34a is configured as an internal locking or coupling mechanism that is configured to engage a stopper 64 of the vial 16. As best shown in FIGS. 5A and 5B and FIGS. 6A and 6B, the first connector 34a includes a sleeve member 72 and a plurality of pre-loaded arms 74 (forming an arm structure). The sleeve member 72 is positioned about the spike member 22, adjacent the proximal end 54 thereof, such that the sleeve member 72 abuts the distal side 28 of base 20. In some embodiments, the sleeve member 72 may be secured to the base 20. Positioned within the sleeve member 72 are the pre-loaded arms 74. According to embodiments, the number of pre-loaded arms 74 provided within sleeve 72 may vary, but is at least two arms, with three arms being shown in the illustrated embodiment. The pre-loaded arms 74 are provided as springy, flap-type arms that are biased radially outward away from the spike member 22 and towards the sleeve member 72, with the arms 74 formed of polypropylene, polyethylene or spring steel, as examples.

In operation of the first connector 34a, the pre-loaded arms 74 may be selectively actuated or moved from within the sleeve member 72 to outside the sleeve member 72. The sleeve member 72 includes a plurality of slots 76 formed therein, with the number of slots 76 matching the number of pre-loaded arms 74 (e.g., three slots 76/arms 74). The plurality of pre-loaded arms 74 is rotatable relative to the sleeve member 72, such that an end of each of the plurality of pre-loaded arms 74 may selectively be aligned with a respective slot 76 and be actuated out through the slot 76, such that a portion of each of the pre-loaded arms 74 may be actuated from inside the sleeve member 72 to outside the sleeve member 72.

For coupling the vial adapter 14a to the vial 16 via the first connector 34a, the vial adapter 14a and the vial 16 are initially aligned and pushed toward one another, such that the spike member 22 is driven into and through the stopper 64 of vial 16. Driving of the spike member 22 into the stopper 64 causes the sleeve member 72 positioned on spike member 22 to also be driven into the stopper 64. With at least a portion of the sleeve member 72 positioned within stopper 64, the sleeve member 72 is held in a fixed position relative to the stopper 64. In some embodiments, and in order to further ensure the sleeve member 72 being retained relative to the stopper 64, an adhesive (e.g., adhesive film) may be applied onto at least part of an exterior surface of the sleeve member 72.

Upon the sleeve member 72 being positioned within stopper 64, the vial adapter 14a and vial 16 may be rotated relative to one another in order to provide for actuation of the pre-loaded arms 74 out from within the sleeve member 72. According to embodiments, a user may grasp the vial adapter 14a to turn the adapter relative to the vial 16, or may grasp the vial 16 to turn the vial 16 relative to the vial adapter 14a. Rotation of the vial adapter 14a and vial 16 relative to one another causes the ends of pre-loaded arms 74 to align with and be actuated out through the slots 76 formed in sleeve member 72. Additional rotation of the vial adapter 14a relative to the vial 16 causes the pre-loaded arms 74 to further protrude out from sleeve member 72. In embodiments where the sleeve member 72 and pre-loaded arms 74 are vertically aligned with the stopper 64 (after insertion of the spike member 22 through stopper 64), additional rotation of the vial adapter 14a relative to the vial 16 causes the pre-loaded arms 74 to dig into the elastomeric material of stopper 64. In embodiments where the sleeve member 72 and pre-loaded arms 74 are distal from the stopper 64 (after insertion of the spike member 22 through stopper 64), additional rotation of the vial adapter 14a relative to the vial 16 causes the pre-loaded arms 74 to protrude out from sleeve member 72, where they may make contact with a back surface 78 of the stopper 64. The pre-loaded arms 74 thus provide multiple connection points between the first connector 34a and the vial 16 that act to prevent wobbling or a loose connection therebetween, thereby securely retaining the vial adapter 14a to the vial 16.

With the first connector 34a coupling to the vial 16 in this manner, vials of any size may be connected to the vial adapter 14a. That is, with the first connector 34a connecting to the stopper 64 of vial 16 via an internal coupling of the pre-loaded arms 74 to the stopper 64, the size of the open head portion 26 of the vial 16 may vary without affecting securing of the vial adapter 14a to the vial 16.

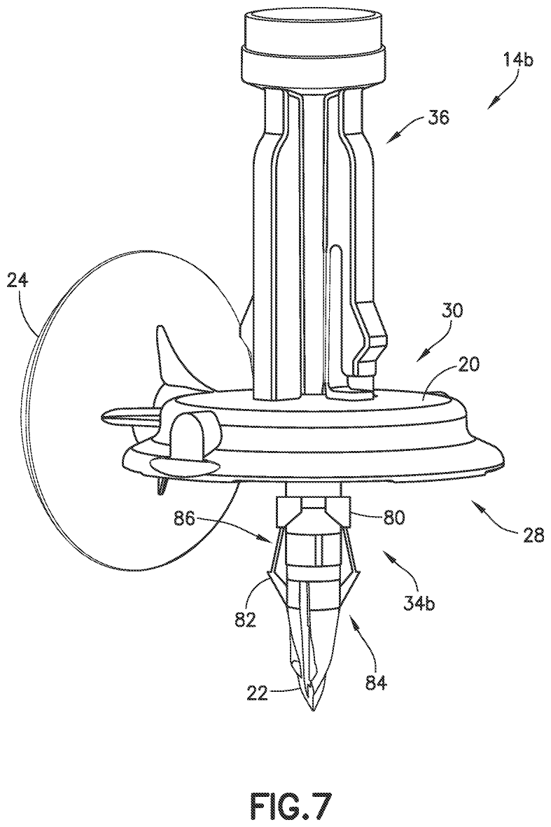

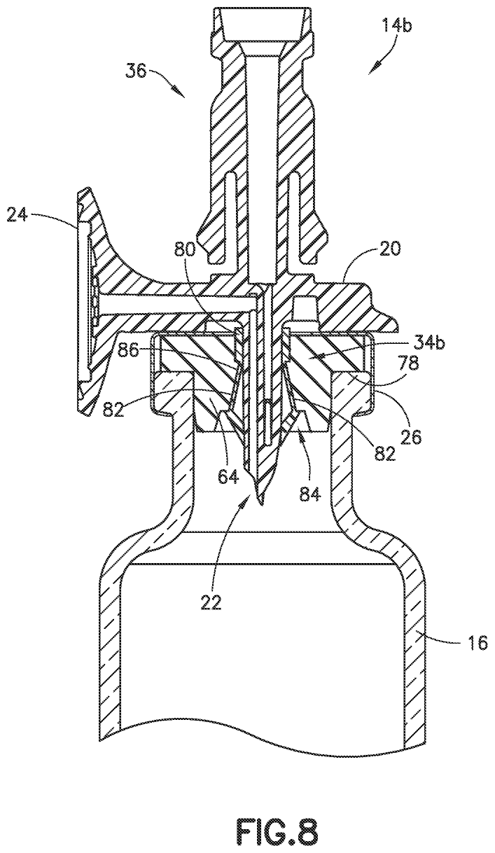

Referring now to FIGS. 7 and 8, a vial adapter 14b is shown according to another aspect of the disclosure. The vial adapter 14b is substantially similar to that of vial adapter 14a shown in FIGS. 2-6 (i.e., base 20, spike member 22, pressure equalization chamber 24, second connector 36 are the same), and thus like members are labeled identically in vial adapter 14b. As provided in detail here below, the first connector 34b provided in vial adapter 14b is structured differently than the first connector 34a of FIGS. 2-6, and provides another means for internally locking/coupling the vial adapter 14b to the vial 16.

As shown in FIGS. 7 and 8, the first connector 34b is configured as an internal locking or coupling mechanism that is configured to engage a stopper 64 of the vial 16. The first connector 34b includes an arm guide 80 and a plurality of expandable arms 82 (forming an arm structure). According to embodiments, the number of expandable arms 82 provided may vary, but is at least two arms, as shown in the illustrated embodiment. The arm guide 80 is positioned about the spike member 22 and is movable relative thereto, with the arm guide 80 sliding axially along the spike member 22 when the spike member 22 is forced into the stopper 64. Each of the expandable arms 82 has a distal end 84 that is joined to the spike member 22 (e.g., molded integrally therewith) near the distal end of the spike member 22. A proximal end 86 of each expandable arm 82 is initially contained within the arm guide 80, such as by being aligned and retained within a channel of the arm guide 80. When the arm guide 80 translates axially along the spike member 22 (i.e., translates proximally along the spike member 22), the proximal end 86 of each expandable arm 82 is freed from the arm guide 80. As each of the expandable arms 82 is biased to expand radially outward relative to the spike member 22, the expandable arms 82 act to deflect/expand radially outward upon the expandable arms 82 being freed from the arm guide 80.

For coupling the vial adapter 14b to the vial 16 via the first connector 34b, the vial adapter 14b and the vial 16 are initially aligned and pushed toward one another, such that the spike member 22 is driven into and through the stopper 64 of vial 16. Driving of the spike member 22 into the stopper 64 causes the arm guide 80 positioned on spike member 22 to be pushed back proximally along the spike member 22. With the arm guide 80 translated back proximally along the spike member 22 and the spike member 22 continuing to be driven into the stopper 64, the expandable arms 82 are also driven into the stopper 64 and are freed from the arm guide 80. After insertion of the spike member 22 through stopper 64, at least a portion of the expandable arms 82 (i.e., the distal end 84 of the expandable arms 82) may be positioned distally at the back surface 78 of the stopper 64. With the expandable arms 82 freed from the arm guide 80 and at least a portion thereof pushed through the stopper 64, the expandable arms 82 thus expand radially outward, so as to apply a radially outward directed pressure against the stopper 64 and/or make contact with a back surface 78 of the stopper 64. The expandable arms 82 thus provide multiple connection points between the first connector 34b and the vial 16 to thereby securely retain the vial adapter 14b to the vial 16.

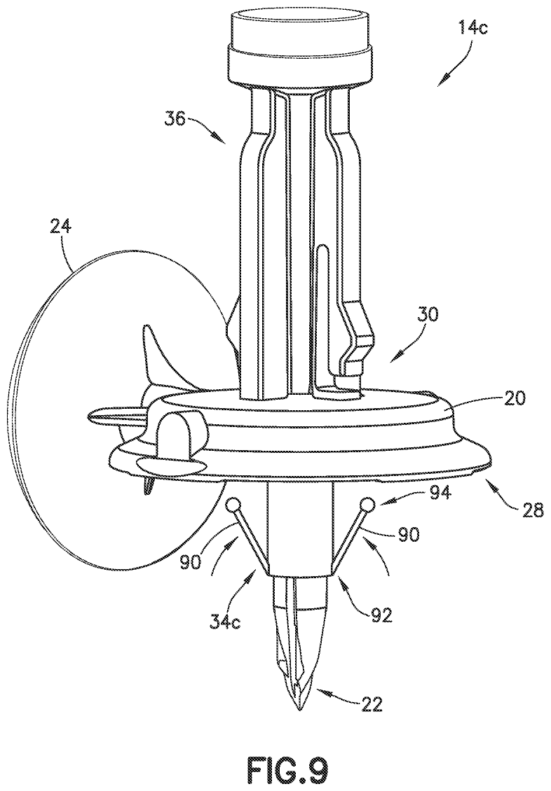

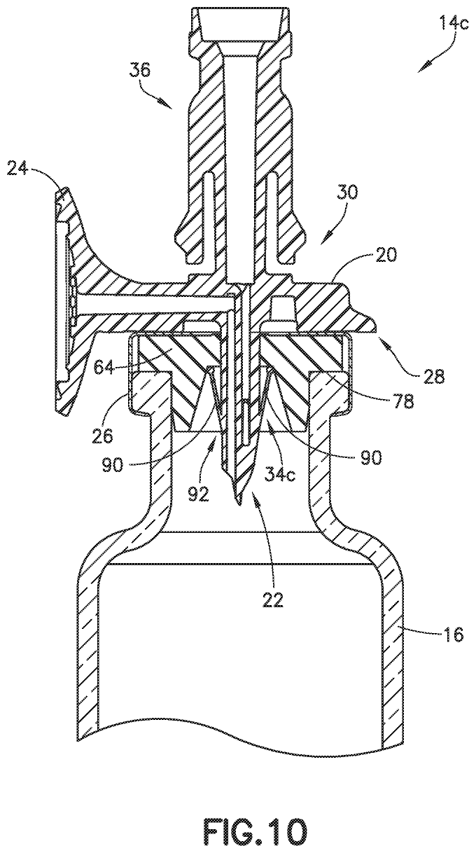

A vial adapter 14c is shown in FIGS. 9 and 10 according to another aspect of the disclosure. The vial adapter 14c is substantially similar to that of vial adapters 14a, 14b shown in FIGS. 2-6 and FIGS. 7-8 (i.e., base 20, spike member 22, pressure equalization chamber 24, second connector 36 are the same), and thus like members are labeled identically in vial adapter 14c. As provided in detail here below, the first connector 34c provided in vial adapter 14c is structured differently than the first connector 34a, 34b of FIGS. 2-6 and 7-8, and provides another means for internally locking/coupling the vial adapter 14c to the vial 16.

As shown in FIGS. 9 and 10, the first connector 34c includes one or more cantilevered retaining arms 90 (forming an arm structure). According to embodiments, the number of cantilevered retaining arms 90 provided may vary-with two arms shown in the illustrated embodiment, but it is recognized that a greater number of arms could be provided or, conversely, only a single conical “arm” could be provided. As shown in FIGS. 9 and 10, a distal end 92 of each cantilevered retaining arm 90 is joined to the spike member 22 (e.g., molded integrally therewith) near the distal end 56 of the spike member 22. The cantilevered retaining arms 90 are angled radially outward away from the spike member 22 when in their default position, such that a proximal end 94 of each cantilevered retaining arm 90 is spaced apart from the spike member 22. Each of the cantilevered retaining arms 90 is configured as a flexible member that deflects radially inward toward the spike member 22 when pressure is applied thereto.

For coupling the vial adapter 14c to the vial 16 via the first connector 34c, the vial adapter 14c and the vial 16 are initially aligned and pushed toward one another, such that the spike member 22 is driven into and through the stopper 64 of vial 16. Driving of the spike member 22 into the stopper 64 brings the cantilevered retaining arms 90 into contact with the stopper 64 and also causes the arms 90 to be driven into the stopper 64. As the cantilevered retaining arms 90 are driven into the stopper 64, the arms 90 are deflected radially inward, such as being deflected by an amount that causes the arms 90 to be laid flat against the spike member 22. Upon the spike member 22 being fully forced through the stopper 64, the cantilevered retaining arms 90 are positioned distally from the stopper 64 and are allowed to deflect/move radially outward back to their default position, with the cantilevered retaining arms 90 engaging a back surface 78 of the stopper 64, as shown in FIG. 10. The cantilevered retaining arms 90 thus provide multiple connection points between the first connector 34c and the vial 16 to thereby securely retain the vial adapter 14c to the vial 16.

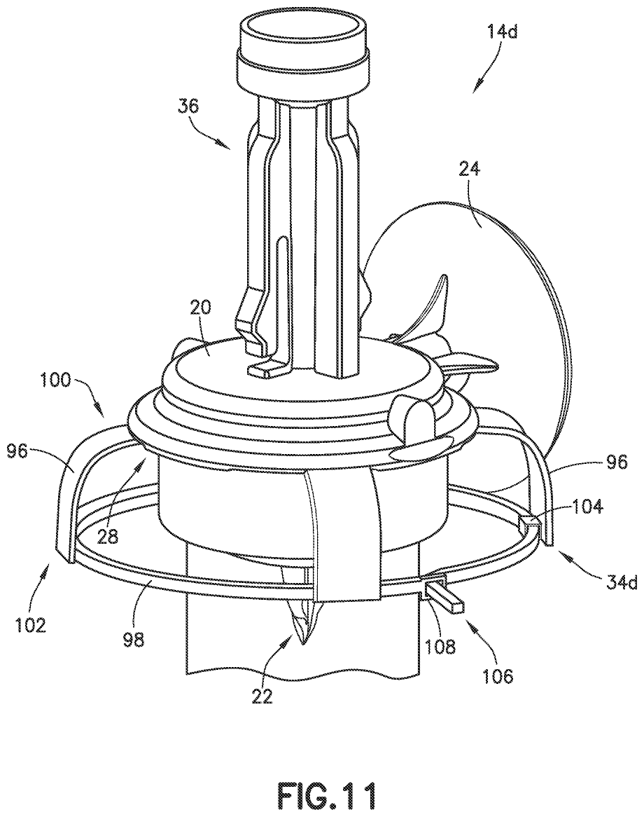

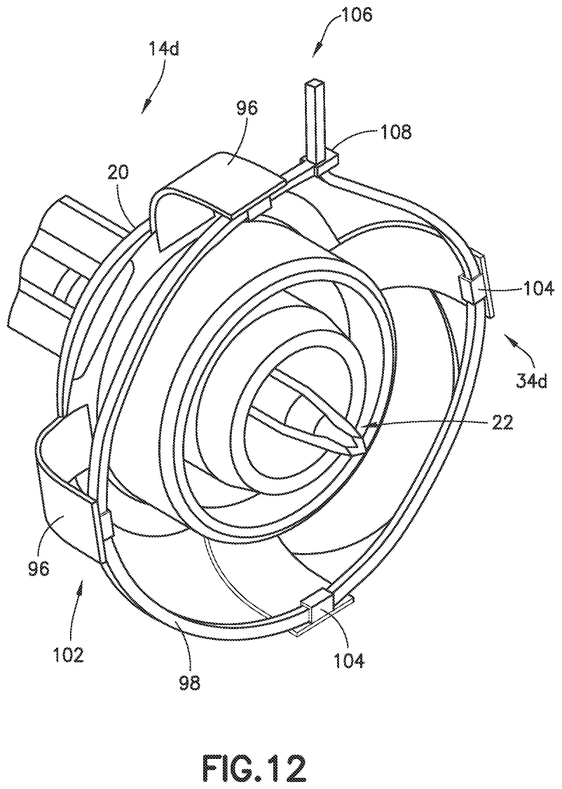

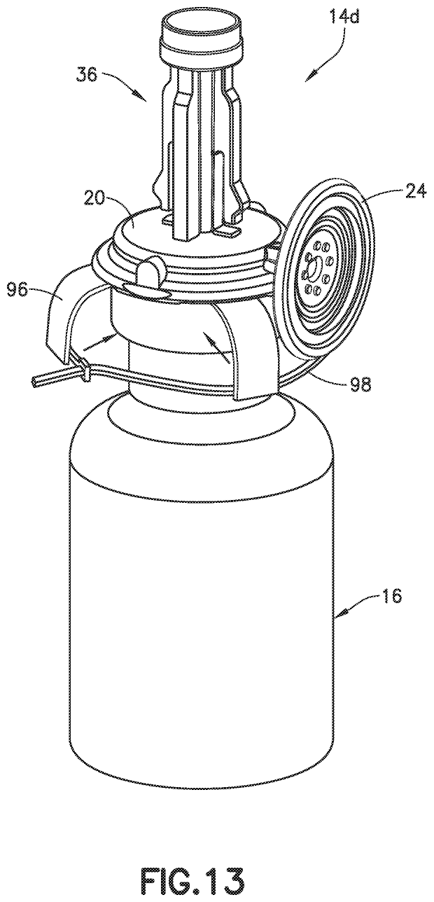

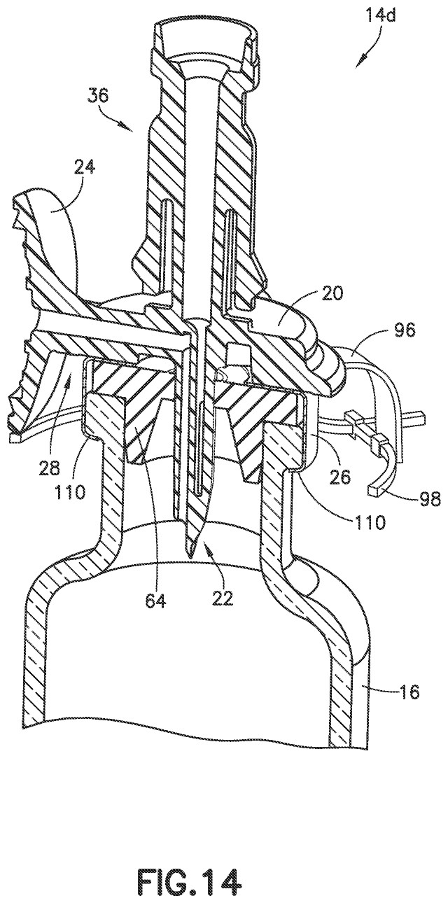

Referring now to FIGS. 11-15, a vial adapter 14d is shown according to additional aspects of the disclosure. The vial adapter 14d is substantially similar to that of vial adapters 14a, 14b, 14c shown in FIGS. 2-6, FIGS. 7-8, and FIGS. 9-10 (i.e., base 20, spike member 22, pressure equalization chamber 24, second connector 36 are the same), and thus like members are labeled identically in vial adapter 14d. As provided in detail here below, the first connector 34d provided in vial adapter 14d is structured differently than the first connector 34a, 34b, 34c of FIGS. 2-6, FIGS. 7-8, and FIGS. 9-10, in that the first connector 34d is configured as an external locking or coupling mechanism that is configured to engage or grasp a head portion 26 of the vial 16.

As shown in FIGS. 11-15, the first connector 34d includes a plurality of grasping arms 96 and an associated actuating member 98 for causing movement of the grasping arms 96 and bringing them into contact with the vial 16. The grasping arms 96 are formed integrally with the base 20 (i.e., a first (or proximal) end 100 of each of the side arms 96 is joined to the base 20) and extend distally and radially outward from the distal side 28 of the base 20-such that the grasping arms 96 are hereafter referred to as “side arms 96.” According to embodiments, the number of side arms 96 provided on vial adapter 14d may vary, but is at least three arms, with four arms being shown in the illustrated embodiment. The side arms 96 are positioned equidistantly about the perimeter of the base 20. The side arms 96 are constructed as flexible side arms 96 that are able to deflect radially inward from an initial or default position when an inwardly directed force is applied thereto, as will be explained further here below.

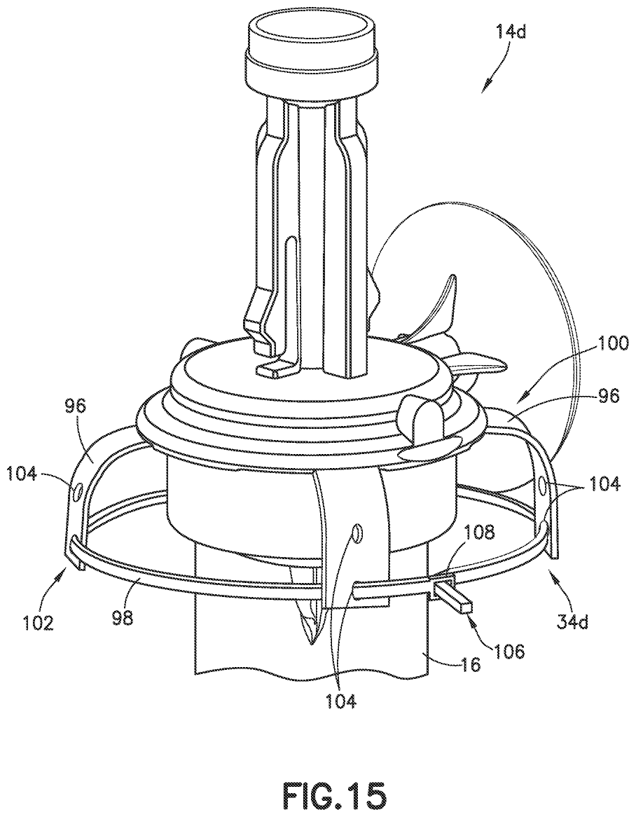

According to one embodiment, the actuating member 98 is provided in the form of a zip tie (hereafter “zip tie 98”) that may be actuated by a user (i.e., healthcare worker) to cause a second (or distal) end 102 of each of the flexible side arms 96 to move radially inward, thereby bringing the plurality of side arms 96 into contact with the vial 16, to secure the vial adapter 14d to the vial 16. The zip tie 98 is looped through an engagement feature 104 formed on each of the flexible side arms 96, so as to secure the zip tie 98 to the flexible side arms 96. In one embodiment, the engagement feature 104 is provided as a hook or channel feature formed adjacent the second end 102 of the side arms 96, on an inner surface thereof, as shown in FIGS. 11-14. In another embodiment, and as shown in FIG. 15, the engagement feature 104 is provided as one or more holes formed in each of the side arms 96, such as adjacent the second end 102 of the side arm 96 and/or near a mid-section of the side arm 96, with the zip tie 98 selectively routed through desired holes to secure the zip tie 98 to the side arms 96. With the zip tie 98 secured to the flexible side arms 96, the zip tie 98 forms a loop-type structure having a free end 106 that is threaded through a tightening feature 108 on the zip tie 98. The free end 106 of the zip tie 98 may be grasped by a user and pulled to tighten the zip tie 98, thereby reducing the size of the zip tie loop and causing the second end 102 of each of the flexible side arms 96 to deflect radially inward, responsive to the inwardly applied pressure applied thereto by the tightened zip tie 98.

For coupling the vial adapter 14d to the vial 16 via the first connector 34d, the vial adapter 14d and the vial 16 are initially aligned and pushed toward one another, such that the spike member 22 is driven into and through the stopper 64 of vial 16. Upon the spike member 22 being fully forced through the stopper 64, the side arms 96 are aligned vertically/axially with the head portion 26 of the vial 16, with the head portion 26 positioned vertically between the first and second ends 100, 102 of the side arms 96. With the vial adapter 14d positioned relative to the vial 16 in a desired location, a user then grasps and pulls the free end 106 of the zip tie 98 that is secured to the flexible side arms 96, thereby reducing the size of a loop formed by the zip tie 98 and causing the second end 102 of each of the flexible side arms 96 to deflect radially inward. Upon the zip tie 98 being tightened by an appropriate amount, the flexible side arms 96 are brought into contact with the vial 16, with the side arms 96 encircling and gripping the head portion 26 and extending underneath a flanged portion 110 on the bottom side of the head portion 26. The flexible side arms 96 thus provide multiple connection points between the first connector 34d and the vial 16 to securely retain the vial adapter 14d to the vial 16.

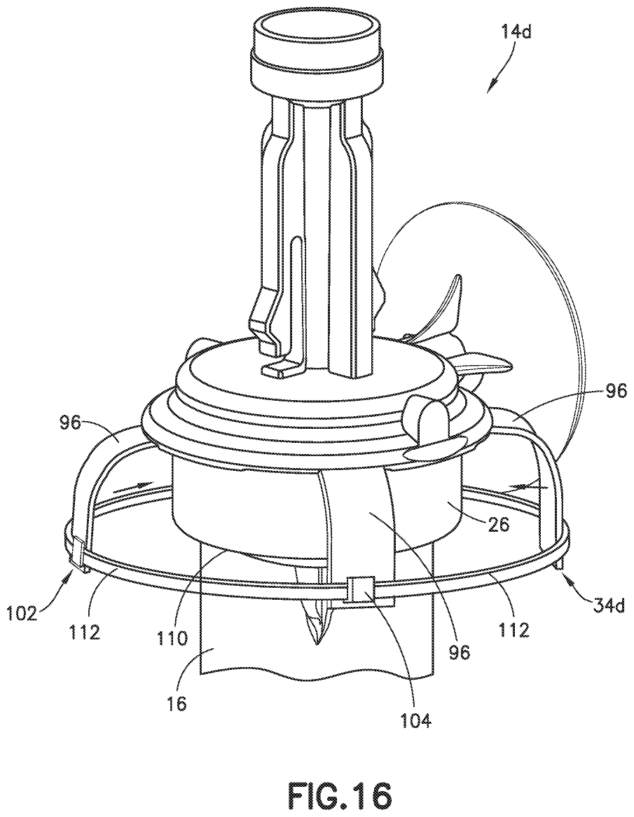

For the vial adapter 14d of FIGS. 11-15, it is recognized that other suitable actuating members could be used in place of the zip tie 98 to apply a tightening (radially inward) force to the flexible side arms 96 to cause deflection thereof. As one example, and as shown in FIG. 16, the actuating member could be provided as an elastomeric ring 112 that is sized and configured to apply a tightening force to the flexible side arms 96 when positioned thereon. When it is desired to secure the vial adapter 14d to the vial 16 (after the spike member 22 has been fully forced through the stopper 64 of vial 16), the elastomeric ring 112 may be stretched out by a user and positioned about the flexible side arms 96 and secured thereto via an engagement feature 104 formed on each of the flexible side arms 96, such as a hook positioned adjacent the second end 102 of the side arms 96, on an outer surface thereof, as shown in FIG. 16. With the elastomeric ring 112 secured to the flexible side arms 96, the elastomeric ring 112 is released by the user, whereby the elastomeric ring 112 constricts from its stretched state back toward its relaxed state, thereby reducing the size of a loop formed by the elastomeric ring 112 and applying a constricting force that causes the second end 102 of each of the flexible side arms 96 to deflect radially inward. Upon the elastomeric ring 112 constricting/relaxing by an appropriate amount, the flexible side arms 96 are brought into contact with the vial 16, with the side arms 96 encircling and gripping the head portion 26 and extending underneath a flanged portion 110 on the bottom side of the head portion 26. The flexible side arms 96 thus provide multiple connection points between the first connector 34d and the vial 16 to securely retain the vial adapter 14d to the vial 16.

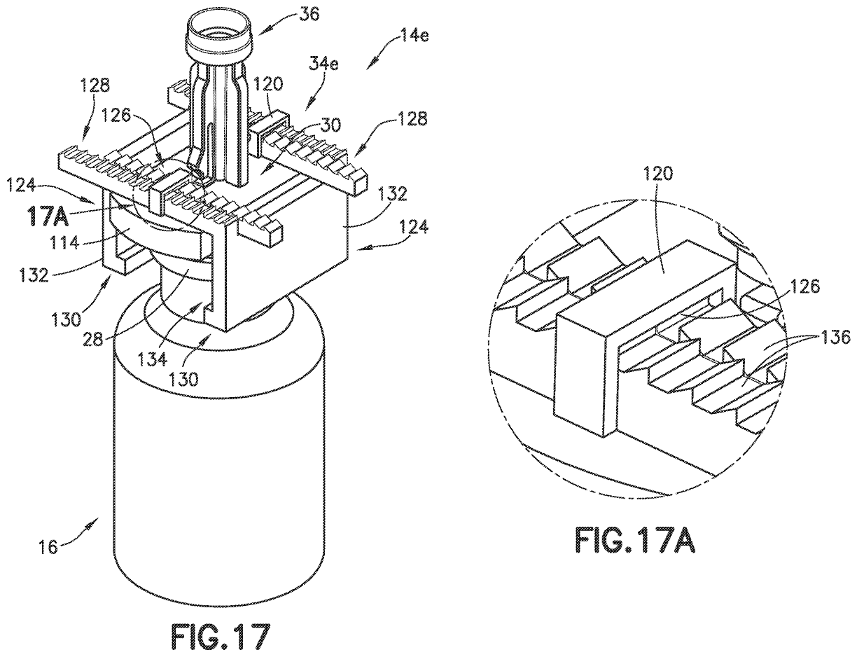

Referring now to FIGS. 17-19, a vial adapter 14e is shown according to still another aspect of the disclosure. Similar to the vial adapters shown previously in FIGS. 2-16, vial adapter 14e includes a spike member 22, pressure equalization chamber 24, and second connector 36 coupled to a base. However, the base 114 in vial adapter 14e is specifically configured to accommodate a first connector 34e that is engageable therewith to provide an external locking or coupling mechanism that is configured to engage or grasp a head portion 26 of the vial 16.

As shown in FIGS. 17-19, the base 114 of vial adapter 14e includes a distal side 28 that faces a vial 16 and a proximal side 30 that faces a syringe adapter. However, base 114 is further configured to include a pair of track housings 120 on the proximal side 30 thereof, with the track housings 120 defining openings through which a plurality of arms may be translated into in a slideable manner, as explained in more detail here below.

In the vial adapter 14e, the first connector 34e is configured as a track system that includes a pair of grasping arms 124 that slide relative to an actuating member 126 to bring the grasping arms 124 into contact with the vial 16. The grasping arms 124 are hereafter referred to as “snap arms 124” based on a snap-type interaction of a track formed on the arms 124 with tooth members (i.e., the actuating members 126—hereafter “tooth members 126”) formed on the track housings 120 of the base 114, as will be explained in further detail below.

The snap arms 124 are configured as generally C-shaped members that each have a first (or proximal) end 128 that extends through a respective track housing 120 of base 114 and a second (or distal) end 130 that is spaced vertically/axially apart from the first end 128 and is generally parallel thereto, with a center portion 132 of the arm orthogonal to and joining the first and second ends 128, 130. The first and second ends 128, 130 of each snap arm 124 are oriented generally parallel to an upper surface of the vial 16 and to a bottom surface of the flanged portion 110 of head portion 26, with the first and second ends 128, 130 spaced apart by a distance that accommodates positioning of the head portion 26 of vial 16 therebetween (i.e., within a channel 134 defined by the C-shaped snap arm 124).

As shown in FIGS. 17-19, the first end 128 of each snap arm 124 is comprised of a pair of grooved tracks 136 each including a series of alternating ridges and depressions on an upper surface thereof. The pair of grooved tracks 136 are positioned on opposing sides of the snap arm 124 and equidistantly about opposing sides of the spike member 22 and second connector 36. The grooved tracks 136 interact with tooth members 126 formed with the track housings 120 as the grooved tracks 136 are slid radially inward into and through the track housings 120. The tooth members 126 protrude down (distally) into track housing 120, such that the tooth members 126 may engage the grooved track 136. As the grooved tracks 136 of each snap arm 124 are slid radially inward into and through the track housings 120, the grooved tracks 136 on each snap arm 124 interact with a respective tooth member 126 via a snap or click-type engagement that allows movement of the grooved tracks 136 radially inward, but prohibits movement of the grooved tracks 136 (and thus the snap arms 124) radially back outward (i.e., the snap arms 124 are locked in place). In this manner, the snap arms 124 can be moved from an initial position where the arms 124 are spaced apart radially outward from the head portion 26 of vial 16, to an engaged position where the arms 124 are brought into contact with the head portion 26 of vial 16, with the head portion 26 seated in the channel 134 defined by each of the C-shaped snap arms 124.

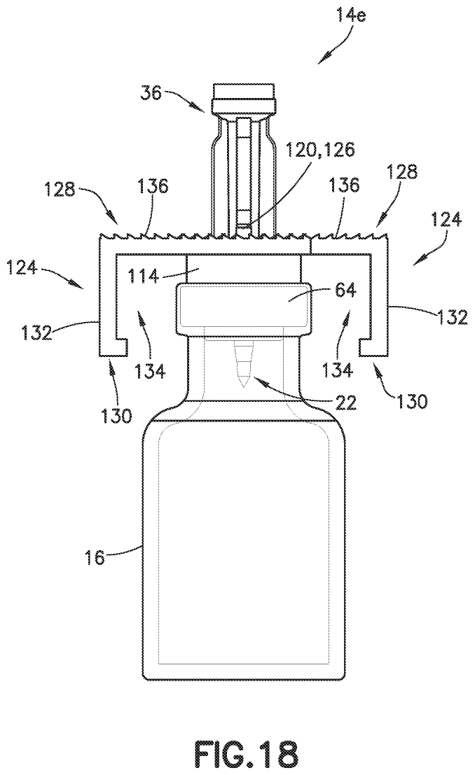

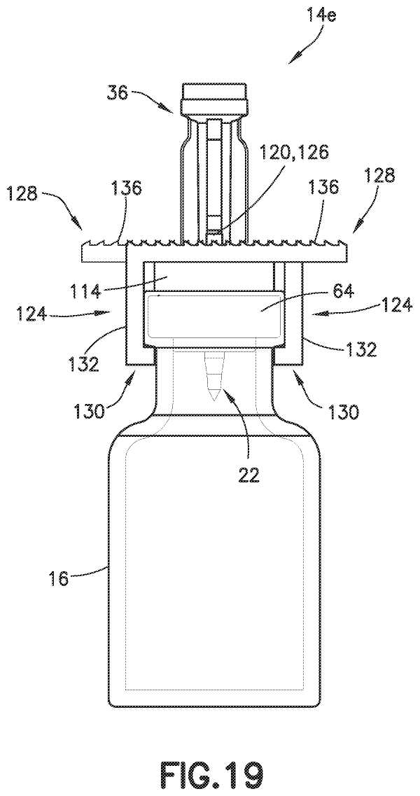

For coupling the vial adapter 14e to the vial 16 via the first connector 34e, the vial adapter 14e and the vial 16 are initially aligned and pushed toward one another, such that the spike member 22 is driven into and through the stopper 64 of vial 16. Upon the spike member 22 being fully forced through the stopper 64, the snap arms 124 are aligned vertically/axially with the head portion 26 of the vial 16, with the head portion 26 positioned vertically between the first and second ends 128, 130 of the snap arms 124. With the vial adapter 14e positioned relative to the vial 16 in a desired location, a user then pushes (“pinches”) the snap arms 124 radially inward from an initial position (FIG. 18) and toward an engaged position (FIG. 19), with the grooved tracks 136 of the snap arms 124 being pushed into the track housings 120 on base 114. As the grooved tracks 136 are pushed radially inward, the tooth members 126 formed in track housings 120 interact with the grooved tracks 136 of each snap arm 124. The snap arms 124 are pushed radially inward until they are brought into contact with the vial 16, with the head portion 26 of the vial being seated in the channel 134 defined by each of the C-shaped snap arms 124. With the snap arms 124 brought into this engaged position, they are locked into place due to the configuration of the grooved tracks 136 and their interaction with the tooth members 126, as the tooth members 126 prevent a radially outward movement of the grooved tracks 136 and snap arms 124. When in the engaged position, the snap arms 124 thus provide multiple connection points between the first connector 34e and the head portion 26, to securely retain the vial adapter 14e to the vial 16.

Beneficially, aspects of the disclosure described herein provide a universal vial adapter that accommodates vials of differing types and/or sizes, as part of a closed-system drug transfer device. The vial adapter includes a (first) connector thereon that is used to secure the vial to the vial adapter, with the connector configured as an internal locking/coupling mechanism that engages a stopper of the vial or as an external locking/coupling mechanism that engages a flanged head portion of the vial. The vial adapter is suitable for use with existing syringe adapters, via a (second) connector thereon, and provides a leak-proof sealing during engagement of the syringe adapter (and a syringe coupled thereto) to the vial-via the vial adapter. The universal adapter eliminates the need for a healthcare facility to keep on-hand multiple vial adapter configurations, thereby simplifying workflow at the healthcare facility and reducing costs.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment may be combined with one or more features of any other embodiment.

The invention claimed is:

1. A vial adapter for accessing a vial, the vial adapter comprising:
a base comprising a distal side and a proximal side, the base having a base lumen extending between the distal side and the proximal side;
a first connector positioned at the distal side of the base and configured to couple with the vial;
a second connector positioned at the proximal side of the base and configured to couple with a fluid container; and
a spike member extending distally from the base and configured to pierce through a stopper of the vial, the spike member defining a spike lumen in fluid communication with the base lumen;
wherein the first connector is positioned on the spike member and includes an arm structure configured to engage the stopper, to secure the vial adapter to the vial,

2. The vial adapter of claim 1, wherein the first connector comprises:
a sleeve member positioned about the spike member, adjacent a proximal end of the spike member so as to abut the base, the sleeve member including a plurality of slots formed therein;
a plurality of pre-loaded arms forming the arm structure, the plurality of pre-loaded arms positioned within the sleeve member and biased radially outward away from the spike member and towards the sleeve member;
wherein the plurality of pre-loaded arms is rotatable relative to the sleeve, such that an end of each of the plurality of pre-loaded arms may be brought into alignment with a respective slot of the plurality of slots and be actuated out through the slot, such that a portion of each of the plurality of pre-loaded arms is positioned outside of the sleeve member.

3. The vial adapter of claim 2, wherein upon insertion of the spike member into the stopper, the sleeve member is retained by the stopper to prevent rotation of the sleeve member relative to the stopper, and wherein a subsequent rotation of the vial adapter causes the plurality of pre-loaded arms to be actuated out through the plurality of slots.

4. The vial adapter of claim 2, further comprising an adhesive applied onto an outer surface of the sleeve member, the adhesive configured to adhere the sleeve member to the stopper.

5. The vial adapter of claim 1, wherein the first connector comprises:
an arm guide positioned about the spike member and translatable axially along the spike member; and
a plurality of expandable arms forming the arm structure, the plurality of expandable arms configured to deflect radially inward and outward relative to the spike member, each of the plurality of expandable arms including:
a distal end joined to the spike member; and
a proximal end movable within the arm guide.

6. The vial adapter of claim 5, wherein upon insertion of the spike member into the stopper, the arm guide is caused to translate proximally along the spike member, such that the proximal end of the each of the plurality of expandable arms is removed from the arm guide, with the plurality of expandable arms engaging with the stopper and applying a radially outward directed pressure against the stopper.

7. The vial adapter of claim 1, wherein the arm structure of the first connector comprises one or more cantilevered retaining arms, with each of the one or more cantilevered retaining arms joined to the spike member adjacent a distal end of the spike member and angled radially outward away from the spike member; and
wherein each of the one or more cantilevered retaining arms is configured to deflect radially inward toward the spike member.

8. The vial adapter of claim 7, wherein insertion of the spike member into the stopper causes the one or more cantilevered retaining arms to contact the stopper and deflect radially inward; and
wherein upon the spike member being fully forced through the stopper, the one or more cantilevered retaining arms are positioned distally from the stopper and move radially outward back to a default position, with the one or more cantilevered retaining arms engaging a back surface of the stopper,

9. The vial adapter of claim 1, wherein the second connector comprises a connector lumen extending through the second connector and in fluid communication with the base lumen and the spike lumen.

10. The vial adapter of claim 1, wherein the spike member comprises a vent lumen formed therein, and wherein the vial adapter further comprises a pressure equalization member coupled to the base and in fluid communication with the vent lumen.

11. A vial adapter for accessing a vial, the vial adapter comprising:
a base comprising a distal side and a proximal end, the base having a base lumen extending between the distal side and the proximal end;
a first connector positioned at the distal side of the base and configured to couple with the stopper;
a second connector positioned at the proximal end of the base and configured to couple with a fluid container; and
a spike member extending distally from the base and configured to pierce through a stopper of the vial, the spike member defining a spike lumen in fluid communication with the base lumen;
wherein the first connector comprises:
a plurality of grasping arms extending distally and radially outward from the distal side of the base, each of the plurality of grasping arms having a first end joined to or engaged with the base and a second end opposite the first end; and
an actuating member engageable by a user to cause the second end of each of the plurality of grasping arms to move radially inward, thereby bringing the plurality of grasping arms into contact with the vial, to secure the vial adapter to the vial.

12. The vial adapter of claim 11, wherein each of the plurality of grasping arms comprises a flexible side arm configured to deflect radially inward.

13. The vial adapter of claim 12, wherein the actuating member comprises a zip tie looped through an engagement feature formed on each of the plurality of side arms, and wherein a tightening of the zip tie causes the second end of each of the plurality of side arms to deflect radially inward and into contact with the vial.

14. The vial adapter of claim 13, wherein the engagement feature comprises one of:
a hook or channel formed adjacent the second end of the side arm and that secures the zip tie to the side arm; or
one or more holes formed in the side arm, with the zip tie routed through a respective hole of the one or more holes to secure the zip tie to the side arm.

15. The vial adapter of claim 12, the actuating member comprises an elastomeric ring engaged with each of the plurality of side arms at the second end thereof, and wherein the elastomeric ring applies a constricting force that causes the second end of each of the plurality of side arms to deflect radially inward and into contact with the vial.

16. The vial adapter of claim 11, wherein the first connector comprises a track system, the plurality of grasping arms comprising a plurality of snap arms each including a pair of grooved tracks formed at the first end thereof, and with the actuating member comprising tooth members provided on a track housing positioned on the proximal side of the base, with the tooth members and the grooved tracks interacting to enable movement of the plurality of snap arms radially inward.

17. The vial adapter of claim 16, wherein each of the plurality of snap arms comprises a generally C-shaped member, with the first end oriented parallel to an upper surface of the vial and having the grooved track formed thereon, and with the second end oriented parallel to the first end.

18. The vial adapter of claim 17, wherein the first end is spaced apart from the second end by a distance that accommodates positioning of a head portion of the vial within a channel defined by the C-shaped grasping arms.

19. The vial adapter of claim 16, wherein the plurality of snap arms are movable radially inward relative to the base, and wherein upon the plurality of snap arms being movable radially inward and into contact with the vial, engagement of the tooth members with the grooved tracks locks the plurality of snap arms in place.

20. The vial adapter of claim 11, wherein the spike member comprises a vent lumen formed therein, and wherein the vial adapter further comprises a pressure equalization member coupled to the base and in fluid communication with the vent lumen.
